(19) United States
(12) Patent Application Publication
(10) Pub. No.: US 2007/0010323 A1
(43) Pub. Date: Jan. 11, 2007

(54) Platform-adaptive gaming

(75) Inventors: Ophir Azulai, Haifa (IL); Arkady Bron, Haifa (IL); Konstantin Kupeev, Haifa (IL); Yuval Noimark, Binyamina (IL); Zohar Sivan, Zichron Ya'akov (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/174,997

(22) Filed: Jul. 5, 2005

(51) Int. Cl. A63F 13/00

(52) U.S. Cl. 463/30

(57) ABSTRACT

A method for adapting a game session on a first device for continued play on a second device, the method including establishing a game session on a first device, scaling the functionality of the game within the game session, and continuing the game session with the scaled game functionality on a second device.

### FIELD OF THE INVENTION

The present invention relates to computer-based games in general, and more particularly to adapting games for operation on multiple computer platforms.

### BACKGROUND OF THE INVENTION

Computer games may be played on various types of computer devices, including personal computers, handled PDA devices, and cellular telephones. To adapt a computer game for multiple platforms, computer game developers typically visually reduce the size of game objects for viewing on smaller displays while attempting to preserve full game functionality. Unfortunately, such scaling often does not take into account differences in capabilities between devices.

### SUMMARY OF THE INVENTION

The present invention discloses a system and method for adapting a game session on a first device for continued play on a second device.

In one aspect of the present invention a method is provided for adapting a game session on a first device for continued play on a second device, the method including establishing a game session on a first device, scaling the functionality of the game within the game session, and continuing the game session with the scaled game functionality on a second device.

In another aspect of the present invention the scaling step includes applying a predefined scaling function.

In another aspect of the present invention the scaling step includes applying a predefined scaling function that changes any of the number, type, or behavior of any object that is active in the game session

In another aspect of the present invention the scaling step includes applying a predefined scaling function that changes the gaming environment of the game session.

In another aspect of the present invention the scaling step includes applying a predefined scaling function that changes a game map of the gaming session.

In another aspect of the present invention the scaling step includes scaling at the first device before the game session is continued at the second device.

In another aspect of the present invention the scaling step includes scaling at a server operative to control any of the devices.

In another aspect of the present invention the scaling step includes scaling at the second device before the game session is resumed thereat.

In another aspect of the present invention the establishing step includes establishing the game session as a multi-user game session on a plurality of devices, the scaling step includes scaling the functionality of the game within the game session with respect to any of the devices, and the continuing step includes continuing the game session with the scaled game functionality on the devices for which the game functionality was scaled.

In another aspect of the present invention the game session is active on at least two of the devices, where a first game session object of a first type on a first one of the devices does not affect a second game session object of a second type on a second one of the devices unless the game session on the second device includes at least one object of the first type.

In another aspect of the present invention a system is provided for adapting a game session on a first device for continued play on a second device, the system including a first device operative to host a game session, and scaling means for scaling the functionality of the game within the game session, and a second device operative to continue the game session with the scaled game functionality.

In another aspect of the present invention the scaling means is operative to apply a predefined scaling function.

In another aspect of the present invention the scaling means is operative to apply a predefined scaling function that changes any of the number, type, or behavior of any object that is active in the game session

In another aspect of the present invention the scaling means is operative to apply a predefined scaling function that changes the gaming environment of the game session.

In another aspect of the present invention the scaling means is operative to scale at the first device before the game session is continued at the second device.

In another aspect of the present invention the scaling means is operative to scale at a server operative to control any of the devices.

In another aspect of the present invention the scaling means is operative to scale at the second device before the game session is resumed thereat.

In another aspect of the present invention the system further includes a plurality of devices operative to collectively host the game session as a multi-user game session, and scaling means operative to scale the functionality of the game within the game session with respect to any of the devices, where any of the devices for which the game functionality was scaled is operative to continuing the game session with the scaled game functionality.

In another aspect of the present invention the game session is active on at least two of the devices, where a first game session object of a first type on a first one of the devices does not affect a second game session object of a second type on a second one of the devices unless the game session on the second device includes at least one object of the first type.

In another aspect of the present invention a computer-implemented program is provided embodied on a computer-readable medium, the computer program including a first code segment operative to establish a game session on a first device, a second code segment operative to scale the functionality of the game within the game session, and a third code segment operative to continue the game session with the scaled game functionality on a second device.

### BRIEF DESCRIPTION OF THE DRAWINGS

The present invention will be understood and appreciated more fully from the following detailed description taken in conjunction with the appended drawings in which:

FIG. 1 is a simplified pictorial illustration of a system for scaling a game's functionality for different computing devices, constructed and operative in accordance with a preferred embodiment of the present invention;

FIG. 2 is a simplified pictorial illustration of a system for scaling a multi-player game's functionality for different computing devices, constructed and operative in accordance with a preferred embodiment of the present invention;

FIG. 3A is a simplified flowchart illustration of a method for defining a scaling function, operative in accordance with a preferred embodiment of the present invention; and

FIG. 3B is a simplified flowchart illustration of a method for modifying a scaling function, operative in accordance with a preferred embodiment of the present invention.

### DETAILED DESCRIPTION OF PREFERRED EMBODIMENTS

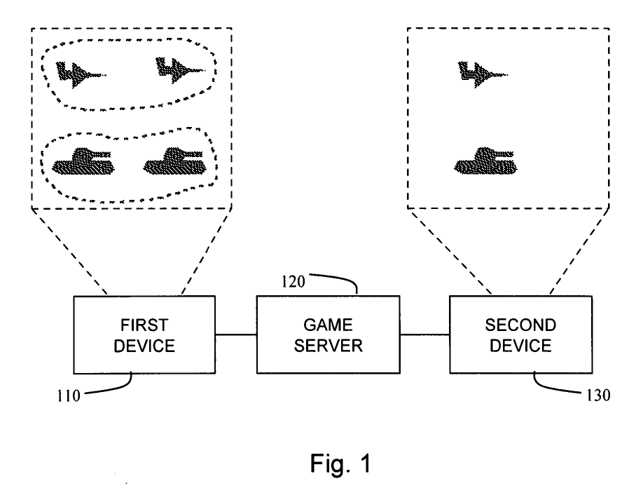

Reference is now made to FIG. 1, which is a simplified pictorial illustration of a system for scaling a game's functionality for different computing devices, constructed and operative in accordance with a preferred embodiment of the present invention. In a typical game-playing scenario, a user may employ a first device 110, such as a personal computer, to play a game. The game may reside wholly on first device 110 or alternatively may be played in conjunction with a game server 120, such as in a network gaming environment, as is well known in the art. Furthermore, the game may be a single-user game, or it may be a multi-user game played with other players.

At some point after the user has begun to play the game on first device 110, the user may wish to continue playing the game, being the same game session currently being played on first device 110, on a second device 130, such as a hand-held computer. The user may instruct game server 120 to continue the game session on second device 130, whereupon game server 120 may pause the game session on first device 110 and resume the game session on second device 130. Game server 120 preferably instructs second device 130 to scale the game functionality appropriately, as is described in greater detail hereinbelow.

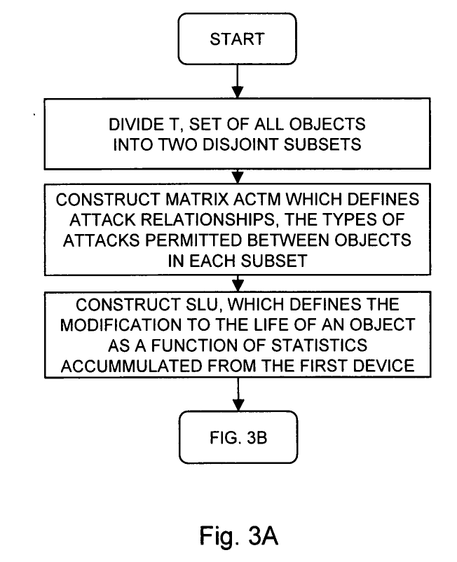

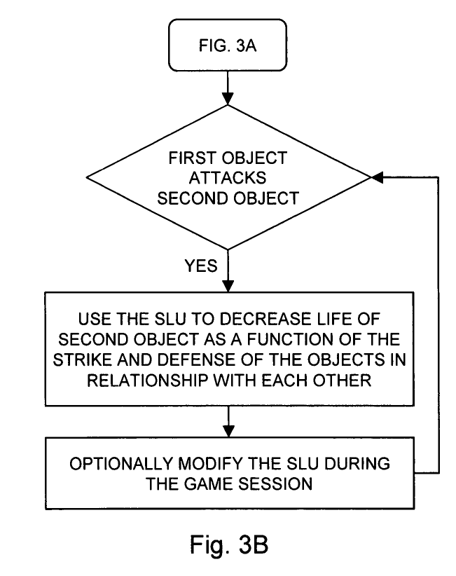

In the example shown in FIG. 1, when the user transitions from first device 110 to second device 130, the game session is modified by scaling the game functionality in accordance with a predefined scaling function. The scaling function may change the number, type (e.g., tank becomes a plane), and/or behavior of any of the objects that are active in the game session, such as reducing the number of tanks and planes active in the game on first device 110 by a factor of 2 while modifying their behavior, such as by allowing them to fire an additional type of missile. In a more complex example, such as is described hereinbelow with reference to FIGS. 3A and 3B, the scaling function may be calculated based on statistical information gathered while the game is played on first device 110. Moreover, the scaling function may be dynamic in nature, such as by continually gathering statistical information while the game is being played on second device 130 and continually updating the scaling function with respect to the newly gathered statistics. Additionally or alternatively, the scaling function may change the gaming environment itself, such as the game map. Play of the scaled game session may then continue on second device 130. At a later time, the user may wish to continue the game session on first device 110, in which case the objects and/or the gaming environment that is active in the game session on second device 110 may again be changed in accordance with a predefined scaling function. For example, should the user have only one tank left on second device 130 when transitioning back to first device 110, a second tank may be added to the game, thus scaling up by a factor of 2. Alternatively, the objects previously removed from the game before the first transition to second device 130 may be re-introduced into the game when the returns to first device 110, such as by increasing the number of tanks to 2 and the number of planes to one.

The system of FIG. 1 may be applied to any type of game where the number, type, and/or behavior of any of the game's elements may be changed. For example, in a poker game the number of computer-controlled players against whom the user plays may be reduced when moving to a platform with a smaller display.

The game scaling process may be performed by automatic or semi-automatic generation of platform-dependant executable files representing full and scaled-down versions of a game from the same source code, or by dynamic adaptation of the compiled code of a game to a specific computer platform, following identification of the capabilities of the platform, in accordance with conventional techniques.

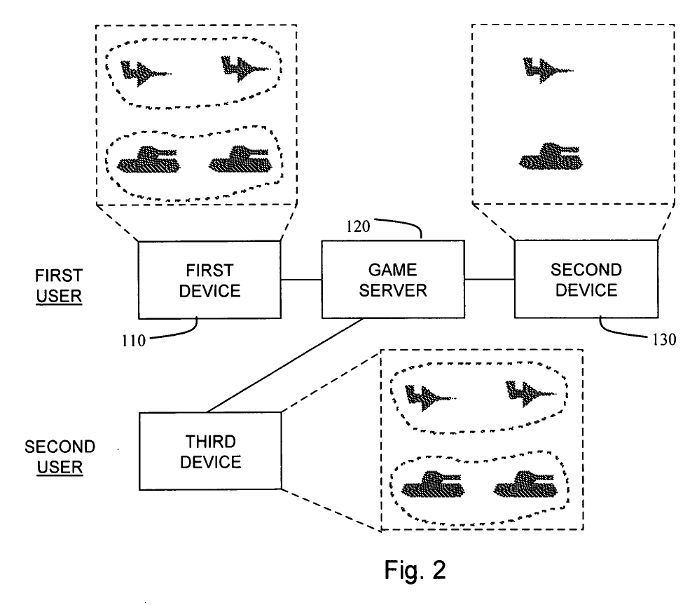

Reference is now made to FIG. 2, which is a simplified pictorial illustration of a system for scaling a multi-player game's functionality for different computing devices, constructed and operative in accordance with a preferred embodiment of the present invention. In the system of FIG. 2 both the first user (FIG. 1) and a second user are playing the same game in a multi-player environment, with the second user playing on a third device 140. After the first user transitions from first device 110 to second device 130 and his version of the game is scaled, the game preferably is played with the constraint that objects in the more restricted environment are not affected by objects in the less restricted environment unless the objects in the more restricted environment also exist in the less restricted environment.

By way of example, FIG. 2 may be extended to a game with three users beginning at a time t1, where the goal of each user is to eliminate the objects the other users, the first user transitions to a second device, such as a portable device, at a time t2. While the full version of the game may continue as before for the second and third users, each of whom has both planes and tanks, the version of the game that is started on the second device for the first user is a scaled-down version where only tanks are displayed. Given the above constraint, the planes of the second and third users may not affect the tanks of the first user. Also, any hidden objects of the first user in the reduced environment may not be affected by the second and third users acting in the full environment.

When the properties of the objects of one user change when transitioning from one device to another, the properties of the remaining objects in that user's new environment may also change in accordance with a scaling factor, as may the objects of the other users who have not transitioned.

Reference is now made to FIG. 3A, which is a simplified flowchart illustration of a method for defining a scaling function, operative in accordance with a preferred embodiment of the present invention, and to FIG. 3B, which is a simplified flowchart illustration of a method for modifying a scaling factor, operative in accordance with a preferred embodiment of the present invention. In the method of FIG. 3A, a scaling factor which determines how a game is scaled when transitioning between devices is calculated, as is now described with respect to the following elements:
a set of the types of the game objects, T={t_1, . . . t_i, . . . , t_I};
a set of the users, P={p_1, . . . , p_n, . . . p_N};
a set of objects currently held by user P, ob(P);
a mapping function of an object to the corresponding element of T, type(ob)
a life function of an object, life(ob), where if life(ob)=0 the object is dismissed from the game;
an attack function act(i,j), which denotes whether the object of type t_i is allowed to attack an object of type t_j where both objects belong to the full game environment. act(i,j) is a binary function, where 1 stands for “true” and 0 for “false”; act(i,j) is preferably represented as an IxI binary matrix, where I is the number of types of objects.
a strike function, strike(i,n,j,m), that denotes the power of the strike of the object of type t_j of player p_n to the object of type t_j of player p_m;
a measure of defense, defense (i,n,j,m), which measures the defense of the object of type t_j of player p₁₃ m when it is attacked by the object of type t₁₃ i of player p_n. Note that defense (i,n,j,m) is typically >=1.
   Given the above elements, the reduction in the life function of the object of type t_j of player p_m as a result of the attack by the object of type t₁₃ i of player p_n may be expressed as:
   strike(i,n,j,m)/defence(i,n,j,m)
   Thus, if an object ob2 is attacked by object ob1, life(ob2) may be decreased by strike (type(ob1),n,type(ob2),m)/defence(type(ob1),n,type(ob2),m), yielding function:
   life(ob2)new=life(ob2)−strike(type(ob1),n,type(ob2),m)/defence(type(ob1),n,type(ob2),m) (F1)
   This may be further simplified using the following abridgments, where
attack(i,n,j,m) denotes an attack by an object of type t₁₃ i of player p_n on an object of type t_j of player p₁₃ m;
dens(i,n,j,m) denotes the expected probability of the strikes of the object of type t₁₃ i on the object of type t_j where player t_n attacks player t_m. This function is preferably predefined and may be updated, during the course of the game, using conventional statistical techniques. Note that for any n,m it may be seen that SUM_{i,j}dens(i,n,j,m)=1.
   An auxiliary function M (i,x,j,y) may also be defined such that:
   M(x,n,y,m)=Sum(dens(i,n,j,m))
   where i,n,j,m denote the players and objects types, Sum is taken over the object types i corresponding to the current value of x, and the object types j corresponding to the current value of y, x,y are assigned the values {“full”, “rest”), where x=“rest” denotes the object types presented in the reduced environment for object n and x=“full” denotes the object types presented in the full (i.e. non-restricted) environment but not in the embedded environment for object n, y=“rest” denotes the object types presented in the embedded environment for object m, and y=“full” denotes the object types presented in the full (i.e. non-restricted) environment but not in the embedded environment for object m.

These functions may be combined to specify a set of operations related to the transition from a first device to a second device. During transition, the complete set of the types of the game objects, T, may be partitioned into two disjoint subsets:
T=Tr U Tf (F2)
where Tr are the object types allowed in the restricted environment and Tf are the object types allowed in the full environment and not allowed in the restricted environment. The condition of such a partition is formulated as follows:
for every type t1 from Tr, an object of type t1 may be attacked by an object of a type t2 from Tr (F3)
This may be formalized as follows:
the sub matrix act′ of the matrix act induced by T→Tr contains at least one 1 in each column. (F4)
A new matrix actm (i,j) may be constructed, which describes whether the object of type t₁₃ i is allowed to attack an object of type t_j if one of the objects belong to restricted game environment. This may be implemented as a binary matrix where 1=“true” and 0=“false”.
The matrix is preferably defined as follows:
actm(i,j)=act(i,j), if i,j belong to Tr, otherwise actm(i,j)=false (F5)
The matrices act and actm represent 2 groups of object pairs:
E1={i,j|act(i,j)=true and actm(i,j)=true}
E2={i,j|act(i,j)=true and actm(i,j)=false} (F6)

Informally, E1 represents the types of the attacks enabled in the restricted game environment, whereas E2 represents the types of the attacks enabled in the full game environment that are disabled if one of the players belongs to the restricted game environment.

Membership of a pair (i,j) in E1, E2 may be verified by computation of the values actm(i,j), act(i,j)

A Supplemental Life Updates matrix (SLU) may be constructed for computing updates to the life functions associated with an object. These updates may be used to preserve the user experience after a transition to another device. For each user in a restricted environment, an SLU matrix may be constructed between the user and each other user, such that at least one of the users from the pair of users belong to the restricted environment.

The SLU matrix is preferably defined as follows:
SLU(i,n,j,m,j′)
where an additional decrease may be applied to the life function for every object of type j′ of player m when attack(i,n,j,m) is performed. If j′=j, this decrease is in addition to that given by (F1). The function SLU is defined for (i,j) in E1.
This function may be defined as follows:
SLU(i,n,j,m,j′)=SUMe SLU0(i,n,j,m,e) (F7)
Where the sum is taken over e, e runs the object type pairs (i′,j′) belonging to E2.
The function SLU0(i,n,j,m, e) may be defined for (i,j) in E1, and e=(i′,j′) in E2 as follows:
SLU0(i,n,j,m,(i′,j′))=dens(i′,n,j′,m)*strike(i′,n,j′,m)/(defenced(i′,n,j′,m)*A*B), (F8)
where A=SUM dens (k,n,l,m), the sum is taken over (k,l) from E1, and B is the number of the objects of type j′ currently held by player m.

Note that SLU(i,n,j,m,j′) may be updated when the number of the object of user m is updated.

The above algorithm may be appreciated by way of example, as follows.

At time t1:

Player 1 owns 2 tanks and 1 plane.
Player 2 owns 1 tanks and 1 plane.
T={“tanks,” planes”}, I=2
P={user1,user2}, N=2
Ob(user1)={“tank1”,“tank2”,“plane1”}.
Ob(user2)={“tank3”,“plane2”}.
   The values of the life function are as follows:
   For user1:
life(tank1)=30;
life(tank2)=15;
life(plane1)=15;
   For user2:
life(tank3)=60;
life(plane2)=50.
   The values of the act function are as follows:
act(tanks,user1,tanks,user2)=1;
act(tanks,user1,planes,user2)=1;
act(planes,user1,tanks,user2)=1;
act(planes,user1,planes,user2)=1;
act(tanks,user2,tanks,user1)=1;
act(tanks,user2,planes,user1)=1;
act(planes,user2,tanks,user1)=1;
act(planes,user2,planes,user1)=1;
   The values of the strike function are as follows:
strike(tanks,user1,tanks,user2)=2;
strike(tanks,user1,planes,user2)=2;
strike(planes,user1,tanks,user2)=6
strike(planes,user1,planes,user2)=8;
strike(tanks,user2,tanks,user1)=2;
strike(tanks,user2,planes,user1)=2;
strike(planes,user2,tanks,user1)=6;
strike(planes,user2,planes,user1)=10;
   The values of the defense function are as follows:
defence(tanks,user1,tanks,user2)=2;
defence(tanks,user1,planes,user2)=1;
defence(planes,user1,tanks,user2)=2;
defence(planes,user1,planes,user2)=1
defence(tanks,user2,tanks,user1)=2;
defence(tanks,user2,planes,user1)=1;
defence(planes,user2,tanks,user1)=3;
defence(planes,user2,planes,user1)=2;
   The values of the dens function are as follows:

dens(*,user1,*,user2):

dens(tanks,user1,tanks,user2)=0.4;

dens(tanks,user1,planes,user2)=0.3;

dens(planes,user1,tanks,user2)=0.2;

dens(planes,user1,planes,user2)=0.1;

dens(*,user2,*,user1):

dens(tanks,user2,tanks,user1)=0.4;

dens(tanks,user2,planes,user1)=0.1;

dens(planes,user2,tanks,user1)=0.4;

dens(planes,user2,planes,user1)=0.1;

Two scenarios are now considered. In the first scenario, the game is played within a desktop environment only. In the second scenario, user 1 switches to PDA at time t1, and at time t2 he returns to the desktop environment. The following illustrates preserving the user game experience for transitions to the mobile environment by similarity of the life function in both scenarios at time t2.

First Scenario.

The users perform the following 20 actions:

attack(tanks,user1,tanks,user2) - - - 4 times;

attack(tanks,user1,planes,user2) - - - 3 times;

attack(planes,user1,tanks,user2) - - - 2 times;

attack(planes,user1,planes,user2) - - - 1 times;

attack(tanks,user2,tanks,user1) - - - 4 times;

attack(tanks,user2,planes,user1) - - - 1 times;

attack(planes,user2,tanks,user1) - - - 4 times;

attack(planes,user2,planes,user1) - - - 1 times;

The attacks occur in the following order:

Action 1:
tank1 (of user1) attack tank3.
By (F1), a new value of life function may be determined as life(tank3)=59
   Action 2:
tank2 (of user1) attack plane2.
By (F1), a new value of life function may be determined as life(plane2)=48
Action 3:
plane2 (of user2) attack plane1.
A new value of life function may be determined as life(plane1)=10
Action 4:
plane2 (of user2) attack tank2.
A new value of life function may be determined as life(tank2)=13
Action 5:
tank1 (of user1) attack tank3.
A new value of life function may be determined as life(tank3)=58
Action 6:
tank3 (of user2) attack tank1
A new value of life function may be determined as life(tank1)=29
Action 7:
tank1 (of user1) attack plane2.
A new value of life function may be determined as life(plane2)=46
Action 8:
tank1 (of user1) attack plane2.
A new value of life function may be determined as life(plane2)=44
Action 9:
plane1 (of user1) attack plane2.
A new value of life function may be determined as life(plane2)=36
Action 10:
tank1 (of user1) attack tank3.
A new value of life function may be determined as life(tank3)=57
Action 11:
plane2 (of user2) attack tank1.
A new value of life function may be determined as life(tank1)=27
Action 12:
tank3 (of user2) attack tank2.
A new value of life function may be determined as life(tank2)=12
Action 13:
tank3 (of user2) attack tank1.
A new value of life function may be determined as life(tank1)=26
Action 14:
plane1 (of user1) attack tank3.
A new value of life function may be determined as life(tank3)=54
Action 15:
plane1 (of user1) attack tank3.
A new value of life function may be determined as life(tank3)=51
Action 16:
plane2 (of user2) attack tank2.
A new value of life function may be determined as life(tank2)=10
Action 17:
tank3 (of user2) attack tank2.
A new value of life function may be determined as life(tank2)=9
Action 18:
tank3 (of user2) attack plane1.
A new value of life function may be determined as life(plane1)=8
Action 19:
plane2 (of user2) attack tank1.
A new value of life function may be determined as life(tank1)=24
Action 20:
tank2 (of user1) attack tank3.
A new value of life function may be determined as life(tank3)=50
   Therefore, at time t2 the values of life function are as follows:
   For user1:

life(tank1)=24;

life(tank2)=9;

life(plane1)=8;

For user2:

life(tank3)=50;

life(plane2)=36;

Second Scenario.

The partition (F2) of set T is performed as follows:

Tr={“tanks”}, Tf={“planes”}. Thus, the condition (F4) holds.
   The matrix actm may be defined by (F5) as follows
actm(tanks, tanks)=true
actm(tanks, planes)=false
actm(planes, tanks)=false
actm(planes, planes)=false
   The sets E1, E2 may be defined by (F6) as follows
E1={(tanks,tanks)}
E2={(tanks,planes), (planes,tanks), (planes,planes)}
   Compute the value of A which is needed for computation of SLU0(*,user1,*,user2,(*,*)):
A=dens(tanks,user1,tanks,user2)=0.4;
   Then, by (F8):
   SLU0(tanks,user1,tanks,user2,(tanks,planes))=dens(tanks,user1,planes,user2)*2/A/1=0.3*2/0.4/1=1.5
   SLU0(tanks,user1,tanks,user2,(planes,tanks))=dens(planes,user1,tanks,user2)*3/A/1=0.2*3/0.4/1=1.5
   SLU0(tanks,user1,tanks,user2,(planes,planes))=dens(planes,user1,planes,user2)*8/A/1=0.1*8/0.4/1=2.0
   Compute the value of A which is needed for computation of SLU0(*,user2,*,user1,(*,*)):
A=dens(tanks,user2,tanks,user1)=0.4;
   Then, by (F8):
   SLU0(tanks,user2,tanks,user1,(tanks,planes))=dens(tanks,user2,planes,user1)*2/0.4/1=0.1*2/0.4/1=0.5
   SLU0(tanks,user1,tanks,user2,(planes,tanks))=dens(planes,user2,tanks,user1)*2/0.4/2=0.4*2/0.4/2=1.0
   SLU0(tanks,user1,tanks,user2,(planes,planes))=dens(planes,user2,planes,user1)*5/0.4/1=0.1*5/0.4/1=1.25
   Computation of SLU
   By (F7):
   SLU(tanks,user1,tanks,user2,tanks)=SLU0(tanks,user1,tanks,user2,(planes,tanks))=1.5
   SLU(tanks,user1,tanks,user2,planes)=SLU0(tanks,user1,tanks,user2,(tanks,planes))+SLU0(tanks,user1,tanks,user2,(planes,planes))=3.5
   and
   SLU(tanks,user2,tanks,user1,tanks)=SLU0(tanks,user2,tanks,user1, (planes,tanks))=1.0
   SLU(tanks,user2,tanks,user1,planes)=SLU0(tanks,user2,tanks,user1,(tanks,planes))+SLU0(tanks,user2,tanks,user1,(planes,planes))=1.75
   In time interval [t1,t2] the users performed the following 8 actions which correspond to the actions in the full environment:
attack(tanks,user1,tanks,user2) - - - 4 times;
attack(tanks,user2,tanks,user1) - - - 4 times;
   The actions are performed in the following order:
Action 1 (=action 1 in the first scenario):

tank1 (of user1) attack tank3.
By (F1), life(tank3) decreases by 1.
   Additionally,

life(tank3) decreases by SLU(tanks,user1,tanks,user2, tanks)=1.5;

life(plane2) decreases by SLU(tanks,user1,tanks,user2, planes)=3.5;

Thus, after the action,

life(tank3)=57.5

life(plane2)=46.5
Action 2(=action 5 in the first scenario):

tank1 (of user1) attack tank3.
By (F1), life(tank3) decreases by 1.
   Additionally,

life(tank3) decreases by SLU(tanks,user1,tanks,user2, tanks)=1.5;

life(plane2) decreases by SLU(tanks,user1,tanks,user2, planes)=3.5;

Thus, after the action,

life(tank3)=55.0;

life(plane2)=43.0;
Action 3 (=action 6 in the first scenario)

tank3 (of user2) attack tank.
By (F1), life(tank1) decreases by 1.
   Additionally,

life(tank1) decreases by SLU(tanks,user2,tanks,user1, tanks)=1.0;

life(tank2) decreases by SLU(tanks,user2,tanks,user1, tanks)=1.0;

life(plane1) decreases by SLU(tanks,user2,tanks,user1, planes)=1.75;

Thus, after the action,

life(tank1)=28.0;

life(tank2)=14.0;

life(plane1)=13.25
Action 4 (=action 10 in the first scenario)

tank1 (of user1) attack tank3
By (F1), life(tank3) decreases by 1.
   Additionally,

life(tank3) decreases by SLU(tanks,user1,tanks,user2, tanks)=1.5;

life(plane2) decreases by SLU(tanks,user1,tanks,user2, planes)=3.5;

Thus, after the action,

life(tank3)=52.5

life(plane2)=39.5
Action 5 (=action 12 in the first scenario)

tank3 (of user2) attack tank2.
By (F1), life(tank2) decreases by 1.
   Additionally,

life(tank1) decreases by SLU(tanks,user2,tanks,user1, tanks)=1.0;

life(tank2) decreases by SLU(tanks,user2,tanks,user1, tanks)=1.0;

life(plane1) decreases by SLU(tanks,user2,tanks,user1, planes)=1.75;

Thus, after the action,

life(tank1)=27.0

life(tank2)=12.0

life(plane1)=11.5
Action 6 (=action 13 in the first scenario)

tank3 (of user2) attack tank1.
By (F1), life(tank1) decreases by 1.
   Additionally,

life(tank1) decreases by SLU(tanks,user2,tanks,user1, tanks)=1.0;

life(tank2) decreases by SLU(tanks,user2,tanks,user1, tanks)=1.0;

life(plane1) decreases by SLU(tanks,user2,tanks,user1, planes)=1.75;

Thus, after the action,

life(tank1)=25.0

life(tank2)=11.0;

life(plane1)=9.75
Action 7 (=action 17 in the first scenario)

tank3 (of user2) attack tank2.
By (F1), life(tank2) decreases by 1.
   Additionally,

life(tank1) decreases by SLU(tanks,user2,tanks,user1, tanks)=1.0;

life(tank2) decreases by SLU(tanks,user2,tanks,user1, tanks)=1.0;

life(plane1) decreases by SLU(tanks,user2,tanks,user1, planes)=1.75;

Thus, after the action,

life(tank1)=24.0

life(tank2)=9.0

life(plane1)=8.0
Action 8 (=action 20 in the first scenario)

tank2 (of user1) attack tank3.
By (F1), life(tank3) decreases by 1.
   Additionally,

life(tank3) decreases by SLU(tanks,user1,tanks,user2, tanks)=1.5;

life(plane2) decreases by SLU(tanks,user1,tanks,user2, planes)=3.5;

Thus, after the action,

life(tank3)=50.00;

life(plane2)=36.0

Therefore, at time t2 the values of life function will be are as follows:

For user1:

life(tank1)=24.0;

life(tank2)=9.0;

life(plane1)=8.0;

For user2:

life(tank3)=50.0;

life(plane2)=36.0;

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention. For example, it is appreciated that game scaling as described hereinabove may be performed at a first device before the user switches from it to a second device, at a server communicating with the various gaming devices, or at the second device before game play is resumed on it.

What is claimed is:

1. A method for adapting a game session on a first device for continued play on a second device, the method comprising:
establishing a game session on a first device;
scaling the functionality of said game within said game session; and
continuing said game session with said scaled game functionality on a second device.

2. The method of claim 1 wherein said scaling step comprises applying a predefined scaling function.

3. The method of claim 1 wherein said scaling step comprises applying a predefined scaling function that changes any of the number, type, or behavior of any object that is active in said game session

4. The method of claim 1 wherein said scaling step comprises applying a predefined scaling function that changes the gaming environment of said game session.

5. The method of claim 1 wherein said scaling step comprises applying a predefined scaling function that changes a game map of said gaming session.

6. The method of claim 1 wherein said scaling step comprises scaling at said first device before said game session is continued at said second device.

7. The method of claim 1 wherein said scaling step comprises scaling at a server operative to control any of said devices.

8. The method of claim 1 wherein said scaling step comprises scaling at said second device before said game session is resumed thereat.

9. A method according to claim 1 wherein:
said establishing step comprises establishing said game session as a multi-user game session on a plurality of devices,
said scaling step comprises scaling the functionality of said game within said game session with respect to any of said devices, and
said continuing step comprises continuing said game session with said scaled game functionality on said devices for which said game functionality was scaled.

10. The method of claim 9 wherein said game session is active on at least two of said devices, wherein a first game session object of a first type on a first one of said devices does not affect a second game session object of a second type on a second one of said devices unless said game session on said second device includes at least one object of said first type.

11. A system for adapting a game session on a first device for continued play on a second device, the system comprising:
a first device operative to host a game session; and
scaling means for scaling the functionality of said game within said game session; and
a second device operative to continue said game session with said scaled game functionality.

12. The system of claim 11 wherein said scaling means is operative to apply a predefined scaling function.

13. The system of claim 11 wherein said scaling means is operative to apply a predefined scaling function that changes any of the number, type, or behavior of any object that is active in said game session

14. The system of claim 11 wherein said scaling means is operative to apply a predefined scaling function that changes the gaming environment of said game session.

15. The system of claim 11 wherein said scaling means is operative to scale at said first device before said game session is continued at said second device.

16. The system of claim 11 wherein said scaling means is operative to scale at a server operative to control any of said devices.

17. The system of claim 11 wherein said scaling means is operative to scale at said second device before said game session is resumed thereat.

18. The system of claim 11 and further comprising:
a plurality of devices operative to collectively host said game session as a multi-user game session; and
scaling means operative to scale the functionality of said game within said game session with respect to any of said devices, wherein any of said devices for which said game functionality was scaled is operative to continuing said game session with said scaled game functionality.

19. The system of claim 18 wherein said game session is active on at least two of said devices, wherein a first game session object of a first type on a first one of said devices does not affect a second game session object of a second type on a second one of said devices unless said game session on said second device includes at least one object of said first type.

20. A computer-implemented program embodied on a computer-readable medium, the computer program comprising:
a first code segment operative to establish a game session on a first device;
a second code segment operative to scale the functionality of said game within said game session; and
a third code segment operative to continue said game session with said scaled game functionality on a second device.
